(19) United States
(12) Patent Application Publication
(10) Pub. No.: US 2006/0109567 A1
(43) Pub. Date: May 25, 2006

(54) Digital camera module and a mobile phone using the digital camera module

(75) Inventor: Ga-Lane Chen, Fremont, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/240,200

(22) Filed: Sep. 30, 2005

(30) Foreign Application Priority Data
Nov. 19, 2004 (CN) 200410052390.3

(51) Int. Cl. G02B 15/14

(52) U.S. Cl. 359/696

(57) ABSTRACT

A digital camera module includes a first barrel (10), a second barrel (20), a beam splitter (30), an IR-cut filter (40) and an image sensor (50). The first barrel receives a first lens element group (12) therein. The second barrel receives a second lens element group (22). The beam splitter is located between the first lens element group and the second lens element group. The presence of the beam splitter may effectively facilitate a decrease in the thickness needed to fit an optical path of a required length (to accommodate optics necessary for high resolution) within a mobile electronic device (e.g., phone, PDA), allowing a portion of the optical path to be positioned in the longer, vertical direction of the device body. This digital camera facilitates the miniaturization of a portable electronic device.

### BACKGROND OF THE INVENTION

1. Field of the Invention

The present invention relates to digital camera modules and, particularly, to a thin digital camera module and a mobile/cellular phone using the thin digital camera module.

2. Discussion of the Invention

In recent years, digital cameras have been rapidly becoming widespread. Such digital cameras convert an optical image to electronic signals by using an image sensor such as a charge coupled devices (CCD) or a complementary metal-oxide semiconductor (CMOS) sensor instead of silver halide film, convert the data to digital form, and record or transfer the digitized data. In such digital cameras, since a CCD and a CMOS sensor each have high number of pixels (about between two million pixels and three million pixels), a high performance digital camera module mounted with an image sensor is in greatly increasing demand. In particular, a compact digital camera is desired. Further, in recent years, digital cameras have been becoming incorporated in or externally attached to personal computers, web cams, mobile computers, mobile telephones, PDAs and the like, which further spurs the demand for a thin digital camera.

The conventional digital camera includes a barrel and an image sensor. Several lens elements are secured in the barrel. The image sensor is located behind the lens elements. The lens elements and the image sensor are disposed on the same optical axis. Accordingly, a thickness of digital camera greatly depends on a thickness of the module, in the optical axis direction. In order to decrease the thickness of the digital camera, the axis-direction thickness has been decreased by means of decreasing the number of lens elements. However, a good image quality is still desired, even under the condition of reduction of the number of lens elements to reduce the module thickness. For a low-resolution digital camera, fewer lens elements indeed may be employed, thereby reducing the thickness of digital camera. Nevertheless, in order to achieve the resolution level desired for high-resolutions digital camera (e.g., about eight mega pixels), the full complement of lens elements is needed to satisfy some requirements so as to secure a better image quality. Thus, with the increasing digital camera's pixel requirements, the axis-direction thickness of previously-available digital cameras have increased accordingly. As such, digital cameras with lens elements aligned along a single axis cannot effectively satisfy the requirement of miniaturization.

Therefore, a thin digital camera module is desired in order to overcome the above-described shortcomings.

### SUMMARY OF THE INVENTION

A thin digital camera module is provided, which may be incorporated in or externally attached to portable electronic devices such as mobile computers, PDAs, mobile phones, etc.

The digital camera module is suitable for a digital camera in a foldable electronic device. A preferred embodiment of the digital camera module includes a first barrel, a second barrel, and a reflection apparatus. The first barrel receives a first lens element group therein. The second barrel receives a second lens element group therein, and the second barrel connects with the first barrel in a range of angles. The reflection apparatus is located between the first lens element group and the second lens element group. The effective thickness of the digital camera may be decreased. This thickness decrease is achieved by providing two optical axis directions, instead of only one, to accommodate all the desired lens elements.

Other advantages and novel features will become more apparent from the following detailed description when taken in conjunction with the accompanying drawings.

### BRIEF DESCRIPTION OF THE DRAWINGS

Many aspects of the digital camera module can be better understood with reference to the following drawings. The components in the drawings are not necessarily to scale, the emphasis instead being placed upon clearly illustrating the principles of the present digital camera module and its potential applications. Moreover, in the drawings, like reference numerals designate corresponding parts throughout the several views.

FIG. 1 is a cut-away view of a digital camera according to one embodiment;

FIG. 2 is a top plan view of a mobile phone according to another embodiment; and

FIG. 3 is a cross-sectional view taken along line III-III of FIG. 2, showing a digital module used in the mobile phone.

### DETAILED DESCRIPTION OF THE EMBODIMENTS

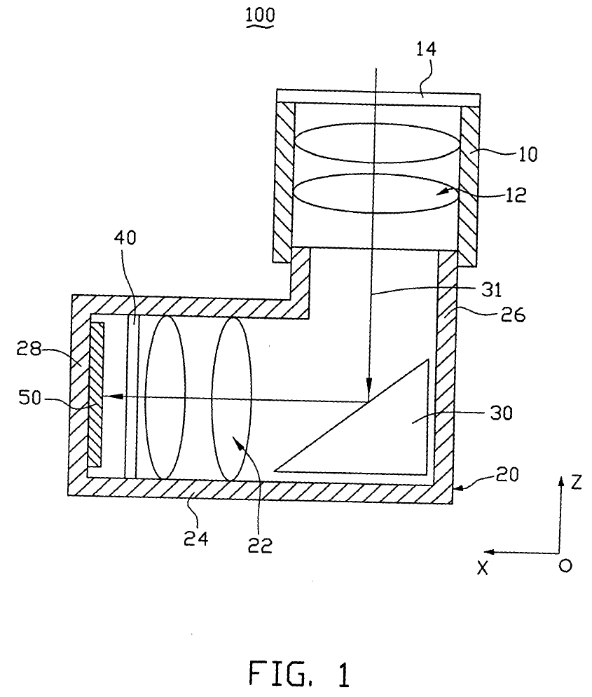

Referring now to the drawings in detail, FIG. 1 shows a digital camera 100 in accordance with one embodiment. A system of coordinates is defined in FIG. 1. The system of coordinates includes an x-axis and a z-axis, perpendicular to each other.

The digital camera 100 generally includes a first barrel 10, a second barrel 20, a reflection or light-redirection apparatus (beam splitter 30, as illustrated), an IR-cut filter 40, and an image sensor 50.

The first barrel 10 is substantially a hollow cylinder. A first lens elements group 12 is received in the first barrel 10. The first lens elements group 12 is made up of several lens elements (not individually labeled), and the first lens elements group 12 firstly receiving light rays which enter from the outside. The first barrel 10 is aligned in the z-axis direction. Also disposed in the first barrel 10 is a glass board 14. The glass board 14 is disposed before the first lens elements group 12 and covers one end of the first barrel 10. As such, the glass board 14 protects the first lens elements group 12 from potentially being scraped or otherwise abraded and keeps dust from entering the system.

The second barrel 20 has a second lens elements group 22 mounted therein. The second lens elements group 22 is made up of several lens elements (not individually labeled). The second barrel 20 includes a housing portion 24, a connection portion 26, and a bottom board 28. The housing portion 24 is aligned in the x-axis direction, and the second lens elements group 22 is received in the housing portion 24. Thereby, an optical axis of the first lens element group 12 is perpendicular to an optical axis of the second lens element group 22. The connection portion 26 is disposed at one end of the housing portion 24, and one end of the connection portion 26 correspondingly communicates with the housing portion 24. One opposite end of the connection portion 26 connects with the first barrel 10 by means of screw thread, the opposite end of the connection portion 26 connecting and communicating with the first barrel 10. A bottom board 28 is disposed in another opposite end of the housing portion 24.

The beam splitter 30 is secured in the second barrel 20 and is located in the connection portion 26 of the second barrel 20. The beam splitter 30 may reflect light rays from the first lens elements group 12 to the second lens elements group 22. An optical path 31 of digital camera 100 is illustrated by a set of orthogonal lines. Essentially, the reflection or light redirection apparatus (e.g., beam splitter 30) provides for a change in direction within the optical path 31. The angle of the optical path 31, while illustrated as orthogonal, can potentially take on any of a range of angles between 0° and 180° (not inclusive), depending on the positioning of the reflection or light redirection apparatus 30. An angle of approximately 90° (e.g., ±10°) does offer the advantage of a reduced potential for image distortion. However, depending on space requirements for camera module 100, other angles may prove more suitable (for example, if the angle between barrels 10 and 20 must be chosen differently), with potential distortion being minimized by methods known in the imaging art.

The IR-cut filter 40 is situated behind the second lens element group 22, so as to protect the image sensor 50. At least one surface of the IR-cut filter 40 is coated with an IR-cut coating. The IR-cut coating can filtrate infrared rays from the air so as to improve the image quality.

The image sensor 50 is usually a charge-coupled device (CCD) or a complementary metal-oxide semiconductor (CMOS). The image sensor 50 is located behind the IR-cut filter 40 and is fixed on the bottom board 28 of the second barrel 20. The image sensor 50 may transfer light signals to electronic signals.

In operation, the light rays reflected from an image object (not shown) pass through the first lens elements group 12. The first lens elements group 12 focuses the light rays, and focused light passes through the beam splitter 30. The beam splitter 30 will lead (i.e., redirect) the light rays to the second lens elements 22. After that, the light rays pass through the IR-cut filter 40, and the infrared rays are filtered therefrom. At the end, the light rays arrive at the image sensor 50. The image sensor 50 will transfer the light signal to an electronic signal, permitting the storage of the image information in a memory of the digital camera. As such, the photographic process is finished. If the image should not prove to be clear enough (i.e., out of focus), the user may adjust the first barrel 10 by hand, thereby changing the focal distance between the first barrel 10 and the second barrel 20.

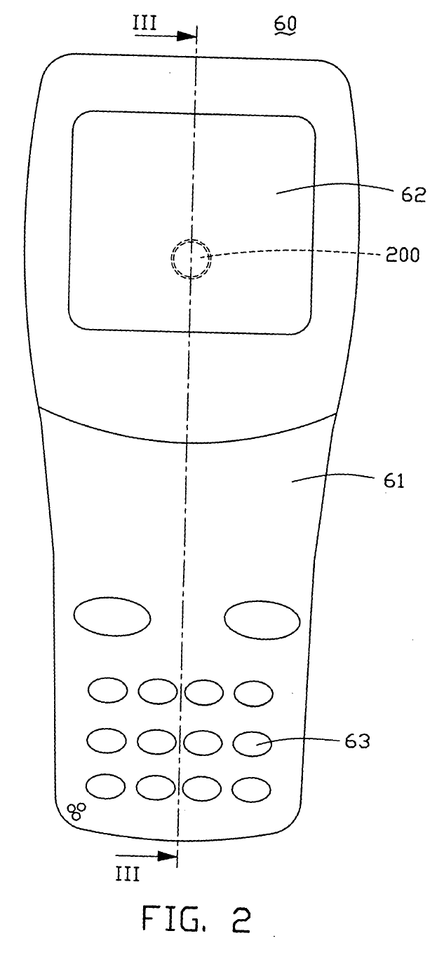

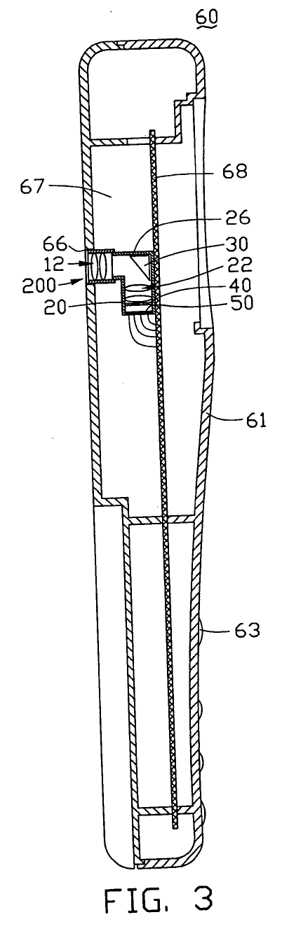

In another embodiment, the digital camera can advantageously be used in portable electronic devices such as mobile phones. Referring to FIG. 2 and FIG. 3, the mobile phone 60 includes a body 61 and incorporates a digital camera 200. One end of the body 61 disposes a display 62, while another opposite end of the body 61 has a keypad 63 disposed thereon. A printed circuit board 68 is housed in the body 61 of the mobile phone 60. An optical opening 66 is defined in a middle of the body 61 of the mobile phone 60, in the side opposite to the side carrying the display 62 of the mobile phone 60. The body 61 has a body cavity 67 therein. A digital camera 200 is secured at or at least proximate optical opening 66 within the body cavity 67, such that light can enter through optical opening 66 and into digital camera 200 (specifically first barrel 10). Accordingly, the optical opening 66 is within the optical path (not labeled in FIG. 3) of the digital camera 200.

The digital camera 200 is mostly the same with the digital camera 100 of the first embodiment. A different point is that the digital camera 200 deletes the bottom board 28 and makes one end of the second barrel 20 open, since the digital camera 200 is already contained within body 61. The image sensor 50 will connect with the printed circuit board 68 of the mobile phone 60 through lead lines (in the form of wires, printed circuitry, pin connectors, etc., depending on the system configuration). The embodiment of the invention may fully use the x-axis direction space and greatly decrease the z-axis height, which would help satisfy the requirement of the camera miniaturization for the portable electronic device.

In still further alternative embodiments, the first barrel 10 is connected with the second barrel 20 at any of a variety of angles, between 0° and 180°, not inclusive. The first barrel 10 and the second barrel 20 may be molded together as a whole during manufacture (molding offers the advantage of simplified manufacture but eliminates the opportunity of manual focus). Alternatively, the first barrel 10 may be fixed relative to the second barrel 20 by means of a glue or other adhesive or by a plastic welding procedure. The connection portion 24 may be separate from the second barrel 20, making both ends of the second barrel 20 open. The end opposite to the bottom board 28 could connect the connection portion 26 by means of screw thread, which may allow adjustment of the x-axis distance (i.e., facilitate focusing).

In a still further alternative embodiment, the beam splitter 10 may be replaced by another reflection apparatus such as a mirror or a prism.

In a still further alternative embodiment, the optical opening 66 for receiving the digital camera module may be defined in other positions of the mobile phone.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

I claim:

1. A digital camera module having an optical path, the digital camera module comprising:
a first barrel receiving a first lens element group therein;
a second barrel receiving a second lens element group therein, the second barrel connecting with the first barrel at an angle; and
a reflection apparatus located between the first lens element group and the second lens element group; and
an image sensor disposed within the optical path after the second lens element group, the image sensor being fixed relative to the second barrel.

2. The digital camera module as claimed in claim 1, wherein the reflection apparatus is one of a beam splitter, a mirror, and a prism.

3. The digital camera module as claimed in claim 2, wherein the reflection apparatus is a beam splitter.

4. The digital camera module as claimed in claim 1, further comprising an IR-cut filter, the IR-cut filter being positioned between the second lens element group and the image sensor.

5. The digital camera module as claimed in claim 1, further comprising a glass board, the glass board being located, relative to the optical path, before the first lens element group and covering one end of the first barrel.

6. The digital camera module as claimed in claim 1, wherein the second barrel comprises a housing portion, a connection portion and a bottom board, the connection portion connecting with the first barrel.

7. The digital camera module as claimed in claim 6, wherein the reflection apparatus is located in the connection portion.

8. The digital camera module as claimed in claim 6, wherein the image sensor is positioned on the bottom board.

9. A digital camera having an optical path, the digital camera comprising:
a first barrel receiving a first lens element group therein, the first lens element group being within the optical path;
a second barrel receiving a second lens element group therein, the second barrel connecting with the first barrel at an angle, the second lens element group being within the optical path, the second lens element group being positioned after the first lens element group with respect to the optical path;
a light redirection apparatus, the light redirection apparatus located between the first lens element group and the second lens element group; and
an image sensor being located behind the second lens element group, relative to the optical path.

10. The digital camera as claimed in claim 9, wherein the light redirection apparatus is one of a beam splitter, a mirror, and a prism.

11. The digital camera as claimed in claim 9, wherein the light redirection apparatus is a beam splitter.

12. The digital camera as claimed in claim 9, further comprising an IR-cut filter, the IR-cut filter behind the second lens elements group and before the image sensor, relative to the optical path.

13. A portable electronic device comprising:
a body including an optical opening and a body cavity therein;
a digital camera module being secured at the optical opening and within the body cavity, the digital camera module having an optical path associated therewith, the digital camera module comprising:
a first barrel receiving a first lens element group therein, the first barrel being secured proximate the optical opening of the body, the optical path beginning at the optical opening;
a second barrel receiving a second lens element group therein, the second barrel connecting with the first barrel at an angle;
a light redirection apparatus located between the first lens element group and the second lens element group, the light redirection apparatus being configured for providing a change in direction within the optical path of the digital camera module; and
an image sensor positioned behind the second lens element group, relative to the optical path of the digital camera module, the image sensor being electronically coupled with the display.

14. The portable electronic device as claimed in claim 13, wherein the body includes a display on a first side thereof and the optical opening in a second side thereof.

15. The portable electronic device as claimed in claim 13, wherein the portable electronic device is a mobile phone.
